(19) United States
(12) Patent Application Publication
(10) Pub. No.: US 2013/0045637 A1
(43) Pub. Date: Feb. 21, 2013

(54) Card Connector

(71) Applicants: Lei Yen, Shanghai (CN); Yunhe Wang, Shanghai (CN); Jianxin Wang, Shanghai (CN); Yi Wei Chang, Taipei (TW)

(72) Inventors: Lei Yen, Shanghai (CN); Yunhe Wang, Shanghai (CN); Jianxin Wang, Shanghai (CN); Yi Wei Chang, Taipei (TW)

(21) Appl. No.: 13/588,385

(22) Filed: Aug. 17, 2012

(30) Foreign Application Priority Data
Aug. 18, 2011 (CN) 201120302549.8

(51) Int. Cl. H01R 24/60

(52) U.S. Cl. 439/637

(57) ABSTRACT

A card connector includes a body, a first contact, and a second contact. The body includes an electrical card receiving groove with an upper sidewall and a lower sidewall. The upper sidewall includes a first contact slot, while the lower sidewall includes a second contact slot. The first contact is positioned in the first contact slot and includes a first securing portion secured to the body, a first elastic portion extending from the first securing portion, and a first contact portion positioned at an end of the first elastic portion. The second contact is positioned in the second contact slot and includes a second securing portion secured in the second contact slot, a second elastic portion extending from the second securing portion, and a second contact portion positioned at an end of the second elastic portion and extending away from the second securing portion and the second elastic portion.

### CROSS-REFERENCE TO RELATED APPLICATION

This application claims priority under 35 U.S.C. §119 to Chinese Patent Application No. 201120302549.8 filed on Aug. 18, 2011.

### FIELD OF THE INVENTION

The invention relates to a card connector, more particularly, relates to a card connector having two rows of contacts.

### BACKGROUND

With reference to FIGS. 1a and 1b, a known first contact 10′ and a known second contact 20′ of a conventional card connector are shown.

As shown in FIG. 1a, the known first contact 10′ includes a first securing portion 101′, a first elastic portion 102′ extending from the first securing portion 101′, and a first contact portion 103′ positioned at an end of the first elastic portion 102′. The first elastic portion 102′ of the known first contact 10′ is configured in a substantially L-shape, and the known first contact 10′ is referred as a curved type contact.

As shown in FIG. 1b, the known second contact 20′ includes a second securing portion 201′, a second elastic portion 202′ extending from the second securing portion 201′, and a second contact portion 203′ positioned at an end of the second elastic portion 202′. The second elastic portion 202′ of the known second contact 20′ is configured in a substantially U-shape, and the known second contact 20′ is referred as a retraced type contact.

Referring to FIG. 1b, since the second elastic portion 202′ of the known second contact 20′ extends is curved to form the substantially U-shape, the known second contact 20′ has a relatively larger height H2′. Furthermore, in order to provide an enough elastic contact force, the height H2′ of the known second contact 20′ cannot be further reduced. Accordingly, it causes the total thickness of the card connector to become relatively larger. Generally, the total thickness of the conventional card connector is larger than 4.0 mm.

Furthermore, as shown in FIG. 1 a, in the conventional card connector the first securing portion 101′ of the known first contact 10′ is configured to be a raised block having a relatively larger thickness and it further causes the height H1′ of the known first contact 10′ to become relatively larger and thereby it is more difficult to reduce the total thickness of the card connector. Similarly, as shown in FIG. 1b, the second securing portion 201′ of the known second contact 20′ is configured to be a raised block having a relatively larger thickness and it furthermore causes the height H2′ of the known second contact 20′ to become relatively larger and thereby it is more difficult to reduce the total thickness of the card connector.

### SUMMARY

The invention has been made to overcome or alleviate at least one aspect of the above mentioned disadvantages. Accordingly, it would be advantageous to provide a card connector having a relatively smaller thickness than the conventional card connector.

The card connector includes a body, a first contact, and a second contact. The body includes an electrical card receiving groove with an upper sidewall and a lower sidewall. The upper sidewall includes a first contact slot, while the lower sidewall includes a second contact slot. The first contact is positioned in the first contact slot and includes a first securing portion secured to the body, a first elastic portion extending from the first securing portion, and a first contact portion positioned at an end of the first elastic portion. The second contact is positioned in the second contact slot and includes a second securing portion secured in the second contact slot, a second elastic portion extending from the second securing portion, and a second contact portion positioned at an end of the second elastic portion and extending away from the second securing portion and the second elastic portion.

### BRIEF DESCRIPTION OF THE DRAWINGS

The above and other features of the present invention will become more apparent by describing in detail embodiments thereof with reference to the accompanying drawings, in which:

FIG. 1a is a side view of a known first contact of a conventional card connector;

FIG. 1b is a side view of a known second contact of the conventional card connector;

FIG. 2 is an exploded perspective view of a card connector according to the invention;

FIG. 3a is a perspective view of a first contact of the card connector according to the invention;

FIG. 3b is a perspective view of a second contact of the card connector according to the invention;

FIG. 4a is a side view of the first contact of the card connector according to the invention;

FIG. 4b is a side view of the second contact of the card connector according to the invention;

FIG. 5 is a cross section view of the card connector according to the invention, in which the first and second contacts both are inserted into the card connector;

FIG. 6 is a cross section view of the card connector according to the invention, in which the first and second contacts are not inserted into the card connector;

FIG. 7a is a side view of a first contact of a card connector according to a second embodiment of the invention;

FIG. 7b is a side view of a second contact of the card connector according to the second embodiment of the invention;

FIG. 8a is a perspective view of a first contact of a card connector according to a third embodiment of the invention; and

FIG. 8b is a perspective view of a second contact of the card connector according to the third the invention.

### DETAILED DESCRIPTION OF THE EMBODIMENT(S)

The embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

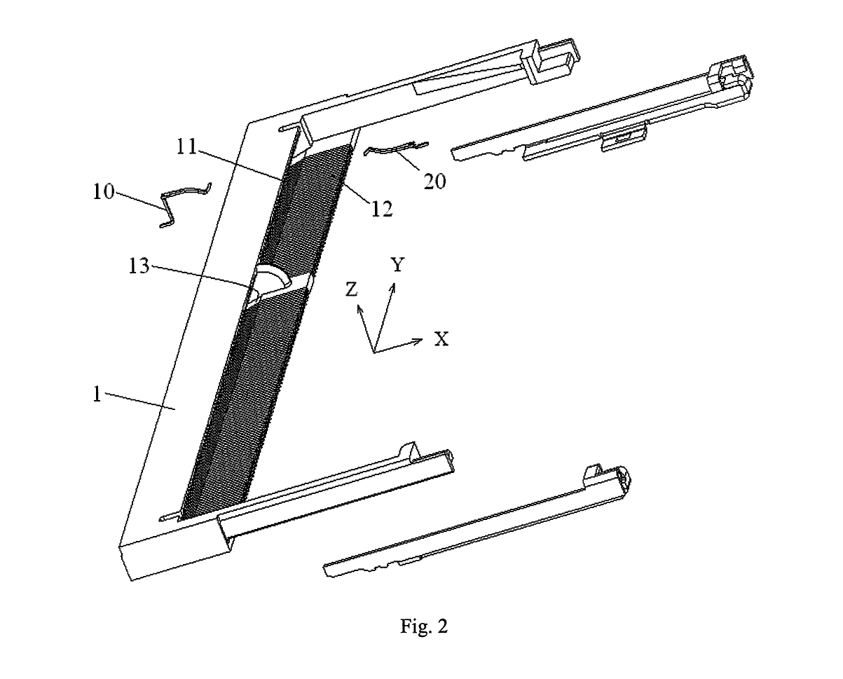

With reference to FIG. 2, a card connector according to the invention is shown with two rows of contacts 10, 20. In use, the card connector is horizontally disposed on a circuit board (not shown), for example, a mother board of a notebook private computer (PC), so as to reduce the total thickness of the notebook private computer.

As shown in FIG. 2, the card connector includes an insulation body 1, for example, made by molding the plastic. The body 1 has a width direction X and a length direction Y that define a horizontal plane parallel to the circuit board. The card connector is horizontally disposed on the circuit board so that surfaces of the card connector are parallel to the horizontal plane and the circuit board. In addition, the body 1 has a height direction (thickness direction) Z perpendicular to the width direction X and the length direction Y.

In the shown embodiment of FIG. 2, the upper and lower surfaces of the body 1 of the card connector both are a flat surface parallel to the horizontal plane so that the card connector can be firmly and horizontally disposed on the surface of the circuit board.

Now, with reference to FIG. 6, a cross section view of the card connector according to the invention is shown, in which the first and second contacts 10, 20 are not inserted into the body 1.

As shown in FIG. 2 and FIG. 6, the body 1 includes a groove 13 for receiving an electrical card module (not shown) therein in the width direction X parallel to the circuit board. The groove 13 has an upper sidewall and a lower sidewall opposite to the upper sidewall. A plurality of first contact slots are formed in the upper sidewall, and a plurality of second contact slots are formed in the lower sidewall. As shown in FIG. 2 and FIG. 6, a row of first contacts 10 may be inserted into the first contact slots 11 from one side (left side of FIG. 6) of the body 1, and a row of second contacts 20 may be inserted into the second contact slots 12 from the other side (right side of FIG. 6) of the body 1, which is opposite the side that the row of first contacts 10 are inserted.

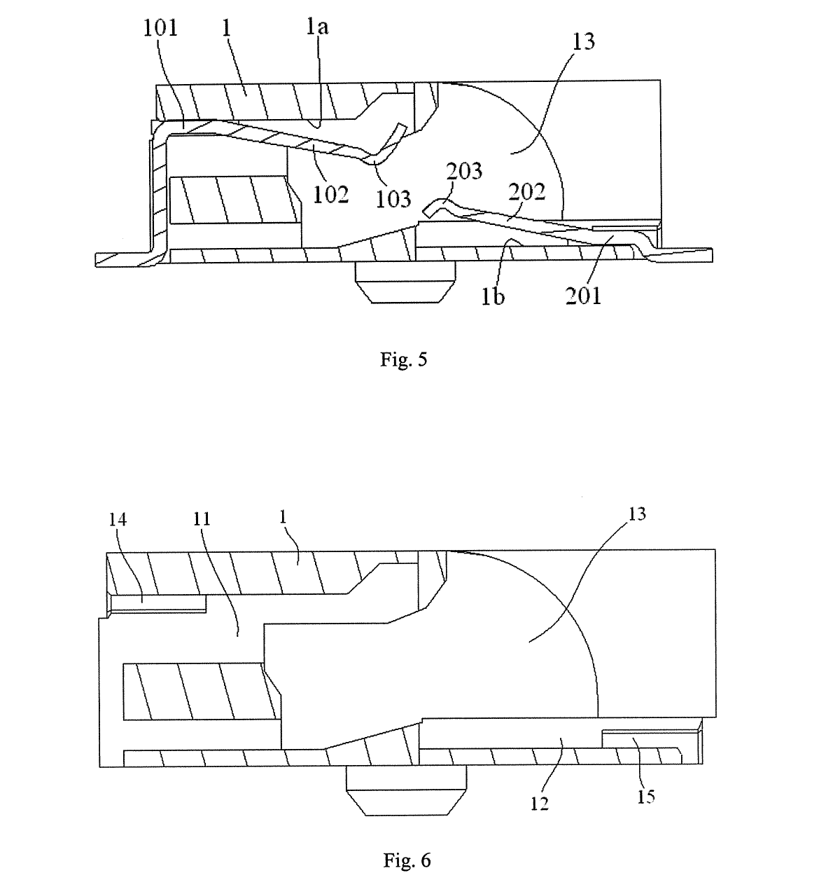

Now with reference to FIG. 5, the card connector is shown in which the first and second contacts 10, 20 both have been inserted into the body 1.

As shown in FIG. 2 and FIG. 5, the lower sidewall of the groove 13 has a lower sidewall length extending in a direction (the width direction X of FIG. 2) of inserting the electrical card module into the groove 13, and the upper sidewall of the groove 13 has a upper sidewall length extending in the direction of inserting the electrical card module into the groove. In the shown embodiment, the lower sidewall length is larger than the upper sidewall length so that the second contact 20 is inserted into the lower sidewall of the groove 13 from an upstream of the direction of inserting the electrical card module.

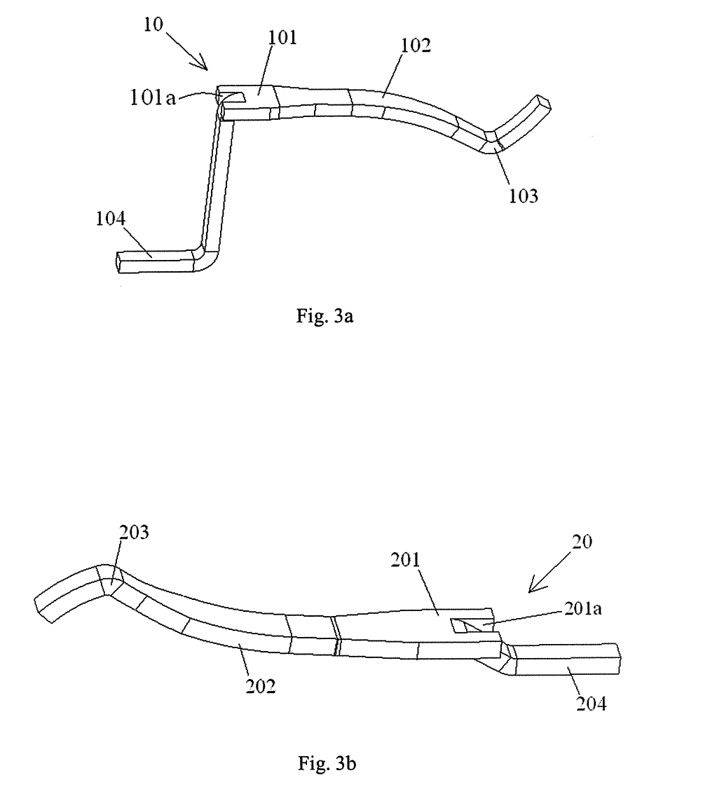

As shown in FIG. 3a and FIG. 5, each contact of the row of first contacts 10 includes a first securing portion 101 secured in the body 1, a first elastic portion 102 extending from one end of the first securing portion 101, a first contact portion 103 positioned at an end of the first elastic portion 102, and a first peg 104 extending from the other end of the first securing portion 101.

As shown in FIG. 3b and FIG. 5, the second contacts 20 includes a second securing portion 201 secured in the body 1, a second elastic portion 202 extending from one end of the second securing portion 201, a second contact portion 203 positioned at an end of the second elastic portion 202, and a second peg 204 extending from the other end of the second securing portion 201.

As shown in FIG. 3a, the first elastic portion 102 of the first contact 10 extends from the first securing portion 101 to the first contact portion 103 in a first route that is not recurved, or bent backwards, that is, there is only one intersection point between the first route and a vertical line in the height direction Z at any one point of the first route.

In the embodiment shown in FIG. 3b, the second elastic portion 202 of the second contact 20 extends from the second securing portion 201 to the second contact portion 203 in a second route that is not recurved, or bent backwards, that is, there is only one intersection point between the second route and a vertical line in the height direction Z at any one point of the second route.

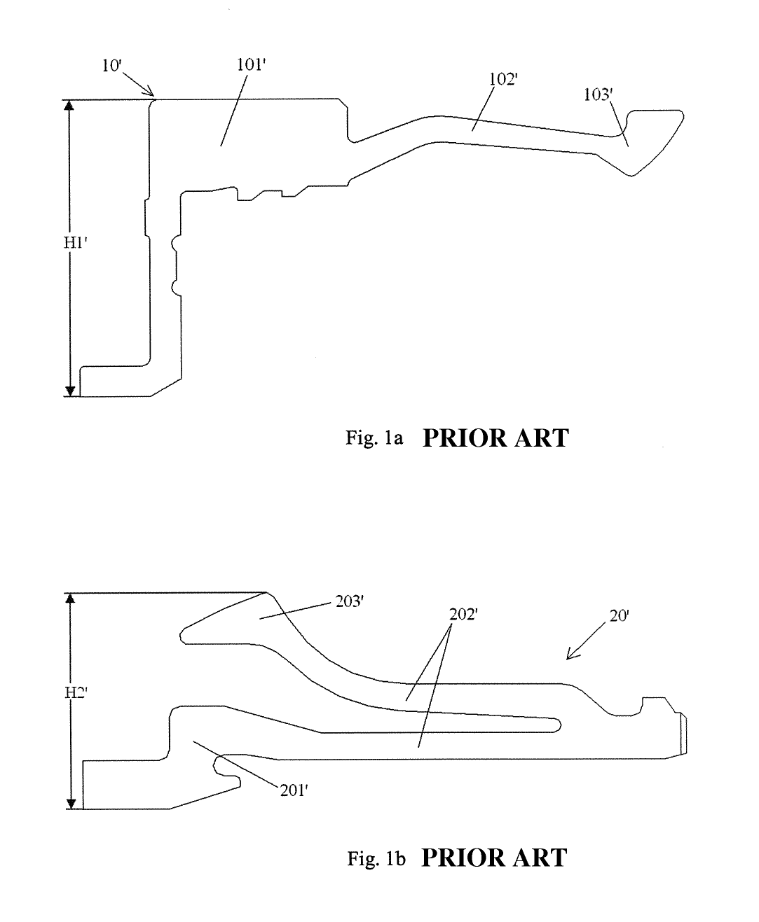

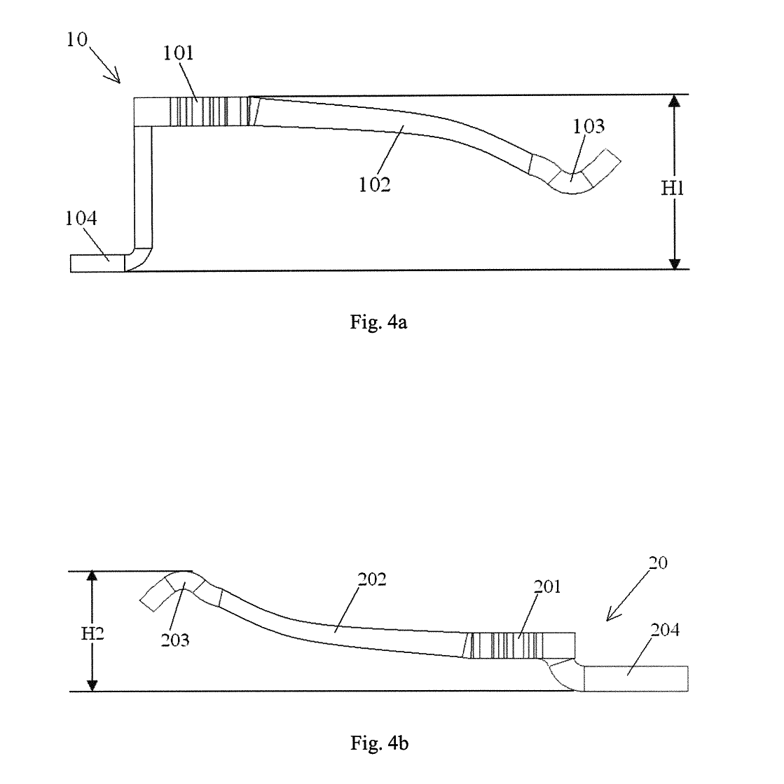

Now with reference to FIG. 4b is a side view of the second contact 20 of the card connector is shown, wherein the second elastic portion 202 of the second contact 20 extends in the second route that is not recurved. The total height H2 of the second contact 20 can be made far less than the total height H2′ of the recurved type known second contact 20′ of the conventional card connector shown in FIG. 1b. Thereby, the total thickness of the card connector of the invention can be reduced.

As shown in FIG. 3a, the first securing portion 101 is flat and has a surface substantially parallel to the surface of the body 1 and the horizontal plane.

Similarly, as shown in FIG. 3b, the second securing portion 201 is flat and has a surface substantially parallel to the surface of the body 1 and the horizontal plane.

In the shown embodiments, since the first securing portion 101 and the second securing portion 201 both are configured to be flat, the height of the first contact 10 and the height of the second contact 20 may be further reduced. Thereby, compared with the first and second contact 10′, 20′ of the conventional card connector shown in FIG. 1a and FIG. 1b, the total thickness of the card connector of the present invention may be further reduced.

It can be clearly seen from FIG. 1a and FIG. 4a, the total height H1 of the first contact 10 of the invention is far less than the total height H1′ of the known first contact 10′ of the conventional card connector.

Also, it can be clearly seen from FIG. 1b and FIG. 4b, the total height H2 of the second contact 20 of the invention is far less than the total height H2′ of the known second contact 20′ of the conventional card connector.

In this way, in the shown embodiments of the invention, the total thickness of the card connector may be equal to or less than 2.6 mm.

With reference to FIG. 3a, in the shown embodiment, the first elastic portion 102 is flat and has a surface width that is gradually reduced from the first securing portion 101 to the first contact portion 103. The first contact 10 with such constructed first elastic portion 102 may ensure a sufficient strength and a sufficient flexibility.

Similarly, as shown in FIG. 3b, the second elastic portion 202 is flat and has a surface width that is gradually reduced from the second securing portion 201 to the second contact portion 203. The second contact 20 with such constructed second elastic portion 202 may ensure a sufficient strength and a sufficient flexibility.

As shown in FIG. 3a, the first securing portion 101 has a surface width that is equal to or larger than the largest width of the surface of the first elastic portion 102. In this way, the first securing portion 101 may have enough strength to firmly secure the first contact 10 in the body 1.

Similarly, please refer to FIG. 3b, in an embodiment of the present invention, the second securing portion 201 has a surface width that is equal to or larger than the largest width of the surface of the second elastic portion 202. In this way, the second securing portion 201 may have enough strength to firmly secure the second contact 20 in the body 1.

As shown in FIGS. 5 and 6, the first contact portion 103 is slightly curved toward an inside of the groove 13, such that the first contact 10 protrudes toward an inside of the groove 13. The second contact portion 203 of the second contact 20 is also slightly curved and protrudes toward the inside of the groove 13. In this way, the first and second contact portion 103, 203 can securely and electrically contact with the electrical card module.

As shown in FIGS. 5 and 6, a first angle is defined between the first elastic portion 102 and an inner wall 1 a of the first contact slot 11 in the upper sidewall of the groove 13, that is, the first elastic portion 102 extends at an inclination, from the first securing portion 101, relative to the inner wall 1a at the first angle. In such way, this design can ensure that the first elastic portion 102 has sufficient flexibility and a sufficient deformation space for facilitating the insertion of the electrical card module.

Similarly, as shown in FIGS. 5 and 6, a second angle is defined between the second elastic portion 202 and an inner wall 1b of the second contact slot 12 in the lower sidewall of the groove 13. The second elastic portion 202 of the second contact 20 extends at an inclination, from the second securing portion 201, relative to the inner wall 1b at the second angle. In such way, it can ensure the second elastic portion 202 has sufficient flexibility and a sufficient deformation space for facilitating the insertion of the electrical card module.

Referring to FIG. 3a, in the embodiment shown, an end of the first securing portion 101 opposite to the first elastic portion 102 is formed in a fork shape having a first opening 101a, and the first peg 104 extends out of the first opening 101a to be soldered onto the circuit board. The fork shaped end of the first securing portion 101 may increase the holding force between the body 1 and the first securing portion 101. Although it is not shown, in another embodiment of the invention, protrusions may be formed on sides of the first securing portion 101 to further increase the holding force between the body 1 and the first securing portion 101.

Similarly, referring to FIG. 3b, an end of the second securing portion 201 opposite to the second elastic portion 202 is formed having a fork shape with a second opening 201 a, and the second peg 204 extends out of the second opening 201a of the second securing portion 201 to be soldered onto the circuit board. The fork shaped end of the second securing portion 201 may increase the holding force between the body 1 and the second securing portion 201. Although it is not shown, in another embodiment of the invention, protrusions may be formed on sides of the second securing portion 201 to further increase the holding force between the body 1 and the second securing portion 201.

As shown in FIGS. 5 and 6, a first securing passageway 14 is formed in the body 1 to secure the first securing portion 101 of the first contact 10 therein; and a second securing passageway 15 is formed in the body 1 to secure the second securing portion 201 of the second contact 20 therein.

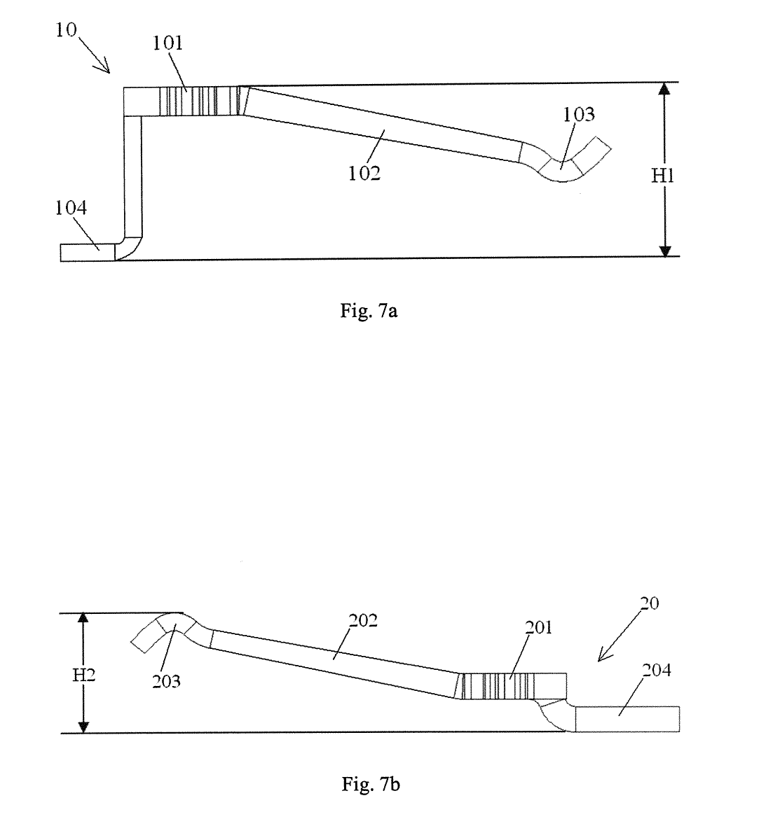

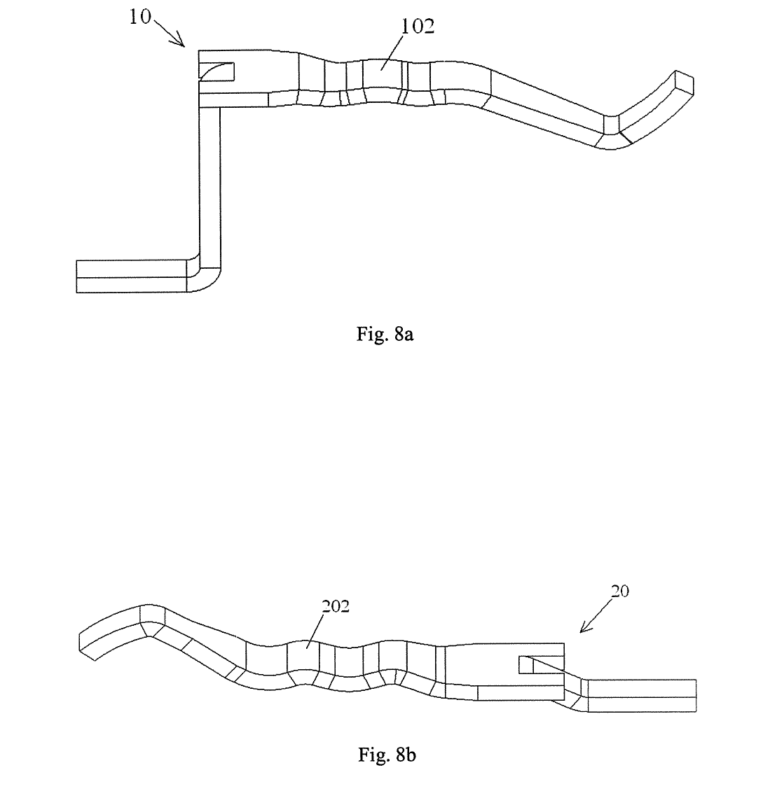

As shown in FIG. 3a, the first elastic portion 102 extends from the first securing portion 101 to the first contact portion 103 along an arc line that is not recurved. But, the invention is not limited to this, for example, as shown in FIG. 7a, the first elastic portion 102 of the first contact 10 may extend at inclination from the first securing portion 101 to the first contact portion 103 along a straight line, or as shown in FIG. 8a, along a wave line that is not recurved, or along a combined line of two or more of the straight line, the arc line and the wave line.

As shown in FIG. 3b, the second elastic portion 202 of the second contact 20 extends from the second securing portion 201 to the second contact portion 203 along an arc line that is not recurved. But, the present invention is not limited to this, for example, as shown in FIG. 7b, the second elastic portion 202 of the second contact 20 may extend at an inclination from the second securing portion 201 to the second contact portion 203 along a straight segment, or as shown in FIG. 8b, along a wave segment that is not recurved, or along a combined of two or more of the straight segment, the arc segment and the wave segment.

In discussed embodiments of the invention, the second elastic portion 202 of the second contact 20 extends such that it is not recurved (retraced) back toward the second securing portion 201. Rather, the second contact portion 203, which extends from an end of the second elastic portion 202, extends away from the second securing portion 201 and the second elastic portion 202. Accordingly, compared with the second elastic portion of the conventional second contact that extends forward and backward in a recurved route, the invention can effectively reduce the height of the second contact and thereby reduce the total thickness of the card connector.

Although several embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “an embodiment” of the invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A card connector, comprising:
a body having an electrical card receiving groove with an upper sidewall and a lower sidewall provided with a first contact slot and a second contact slot respectively;
a first contact positioned in the first contact slot and having a first securing portion secured to the body, a first elastic portion extending from the first securing portion, and a first contact portion positioned at an end of the first elastic portion; and
a second contact positioned in the second contact slot and having a second securing portion secured in the second contact slot, a second elastic portion extending from the second securing portion, and a second contact portion positioned at an end of the second elastic portion and extending away from the second securing portion and the second elastic portion.

2. The card connector according to claim 1, wherein a lower sidewall length is greater than an upper sidewall length.

3. The card connector according to claim 1, wherein the first contact portion extends away from the first securing portion and the first elastic portion.

4. The card connector according to claim 3, wherein the first contact portion extends toward the second contact.

5. The card connector according to claim 4, wherein the second contact portion extends toward the first contact.

6. The card connector according to claim 1, wherein the second elastic portion includes one or more of a straight segment, an arc segment, and a wave segment.

7. The card connector according to claim 6, wherein the first elastic portion includes one or more of a straight segment, an arc segment, and a wave segment.

8. The card connector according to claim 1, wherein the first elastic portion is one or more of a straight segment, an arc segment, and a wave segment.

9. The card connector according to claim 1, wherein the card connector has a total thickness that is equal to or less than 2.6 mm.

10. The card connector according to claim 1, wherein the first securing portion has a flat major surface that is substantially parallel to a surface of the body.

11. The card connector according to claim 10, wherein the second securing portion includes a flat major surface that is substantially parallel to the surface of the body.

12. The card connector according to claim 11, wherein the first elastic portion includes a flat major surface having a width that decreases from the first securing portion to the first contact portion.

13. The card connector according to claim 12, wherein the second elastic portion includes a flat major surface having a width that decreases from the second securing portion to the second contact portion.

14. The card connector according to claim 13, wherein the width of the flat major surface of the first securing portion is greater than or equal to the width of the flat major surface of the first elastic portion.

15. The card connector according to claim 14, wherein the width of the flat major surface of the second securing portion is greater than or equal to the width of the flat major surface of the second elastic portion.

16. The card connector according to claim 1, wherein the first contact portion is curved toward an inside of the electrical card receiving groove.

17. The card connector according to claim 16, wherein the second contact portion is curved and protrudes toward the inside of the electrical card receiving groove.

18. The card connector according to claim 1, wherein an end of the first securing portion opposite to the first elastic portion has a fork shape and a first opening.

19. The card connector according to claim 18, wherein an end of the second securing portion opposite to the second elastic portion has a fork shape and a second opening.

20. The card connector according to claim 19, wherein the first contact further includes a first protrusion extending out of the first opening to be soldered onto a circuit board.

21. The card connector according to claim 20, wherein the second contact further includes a second protrusion extending out of the second opening to be soldered onto the circuit board.

22. The card connector according to claim 1, further comprising a first securing passageway formed in the body.

23. The card connector according to claim 22, further comprising a second securing passageway formed in the body.
